(19) United States
(12) Patent Application Publication
(10) Pub. No.: US 2009/0290837 A1
(43) Pub. Date: Nov. 26, 2009

(54) OPTICAL DEVICES FOR COUPLING OF LIGHT

(75) Inventors: Xia Chen, Hong Kong (CN); Chao Li, Hong Kong (CN); Hon Ki Tsang, Hong Kong (CN)

Correspondence Address: DARBY & DARBY P.C., P.O. BOX 770, Church Street Station, New York, NY, 10008-0770, US

(73) Assignee: The Chinese University of Hong Kong, Hong Kong (CN)

(21) Appl. No.: 12/470,754

(22) Filed: May 22, 2009

Related U.S. Application Data
(60) Provisional application No. 61/055,273, filed on May 22, 2008.

(51) Int. Cl. G02B 6/34

(52) U.S. Cl. 385/37; 385/43

(57) ABSTRACT

An optical device and an optical system are provided for coupling of light. The optical device comprises a planar substrate; and an optical waveguiding layer disposed on the planar substrate. The optical waveguiding layer comprises a grating portion for coupling light between a planar waveguide and an optical fiber; and a tapered guiding portion for converting the mode size between the fiber and the planar waveguide. The grating portion comprises a first grating section having non-uniform periods.

This application claims the benefit of U.S. provisional patent application No. 61/055,273 filed on May 22, 2008 which is explicitly incorporated by reference in its entirety as part of this application.

### TECHNICAL FIELD

The present application relates to an optical device for coupling of light.

### BACKGROUND

Light can be propagated through optical fibers as well as planar waveguide devices.

Optical fibers are typically in the form of a thin strand of glass having a central core of circular cross section peripherally surrounded by concentric cladding glass. The fiber core has a higher refractive index than the cladding so that the light is retained in the core by total internal reflection and propagates in a fiber mode.

Planar waveguide devices are typically formed by thin layers of higher index material (for example silicon) supported by a lower index substrate (for example silica). The waveguide core is typically of rectangular cross section. The core region is formed, as by etching of a masked surface, into a patterned configuration that performs a desired function.

Since the core size for a typical optical fiber is significantly larger than the core size for a planar waveguide, waveguide grating couplers and adiabatic tapers with polished facets are typically used for coupling light between planar waveguides and optical fibers.

### SUMMARY

In one aspect, an optical device is provided for coupling light between a planar waveguide and an optical fiber. The optical device comprises a planar substrate; and an optical waveguiding layer disposed on the planar substrate. The optical waveguiding layer comprises a grating portion for coupling light between the planar waveguide and the optical fiber; and a tapered guiding portion for converting the mode size between the fiber and the planar waveguide. The grating portion comprises a first grating section having non-uniform periods.

In one implementation, the grating portion may comprise a second grating section having uniform periods.

In another implementation, the first grating section of the grating of the optical device may comprise linearly chirped periods.

In yet another implementation, the optical fiber may be positioned normal to a surface of the grating portion.

In another aspect, an optical system is provided. The optical system comprises an optical fiber; a planar waveguide; and a coupling device for coupling light between the planar waveguide and the optical fiber. The coupling device comprises a planar substrate; and an optical waveguiding layer disposed on the planar substrate. The optical waveguiding layer comprises a grating portion for coupling light between the planar waveguide and the optical fiber; and a tapered guiding portion disposed to convert the mode size between the fiber and the planar waveguide. The grating portion comprises a first grating section having non-uniform periods.

In one implementation, the grating portion may comprise a second grating section having uniform periods.

In another implementation, the first grating section of the grating of the optical device may comprise linearly chirped periods.

In yet another implementation, the optical fiber may be positioned normal to a surface of the grating portion.

### BRIEF DESCRIPTION OF THE DRAWING

FIGS. 1a and 1b are schematic views of an optical device according to a first embodiment;

FIG. 2 is a schematic cross-section of an optical device according to a second embodiment;

FIG. 3 is a curve showing comparison on coupling efficiency (solid) and back reflection into waveguide (dashed) between the optical device of the second embodiment and a traditional uniform grating coupler;

FIG. 4 is a curve showing the measured coupling efficiency versus wavelength by using the optical device of the second embodiment;

FIG. 5 is a curve showing the Fabry-Perot interference oscillation of the waveguide with uniform grating couplers versus that with optical device of the second embodiment; and

FIG. 6 is a graph of the waveform of the vibration produced by the system using the optical device of the second embodiment after it is powered up.

### DETAILED DESCRIPTION

Hereinafter, a detailed description will be given with reference to the appended drawings.

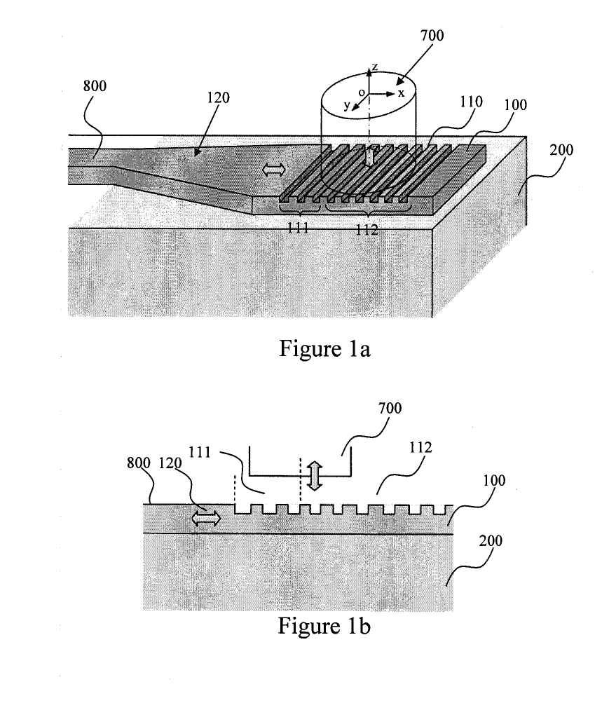

FIGS. 1a and 1b show an optical device for coupling light between an optical fiber 700 and a planar waveguide 800 according to a first embodiment. As shown in FIG. 1a, the optical device comprises an optical waveguiding layer 100 disposed on a planar substrate 200. The optical waveguiding layer 100 includes a grating portion 110 and a tapered guiding portion 120. The grating portion 110 is employed to optically couple light between the planar waveguide 800 and the optical fiber 700. The tapered guiding portion 120 is disposed to optically connect between the grating portion 110 and the planar waveguide 800 and employed to transform the mode between the relatively large dimensioned optical fiber 700 and the relatively small dimensioned planar waveguide 800.

In the first embodiment, as shown in FIGS. 1a and 1b, the grating portion 110 comprises a first grating section 111 having non-uniform periods. According to the present embodiment, the grating section 111 with non-uniform periods can reduce the back reflection and enhance the coupling efficiency.

According to an implementation, the grating section 110 may further comprise a second grating section 112 having uniform periods.

According to another implementation, the fiber 700 is disposed normal to the waveguide grating 110 of the optical waveguiding layer 100. The waveguide grating 110 includes a first grating section 111 having non-uniform periods which is designed to efficiently couple the light between the fiber 700 and the planar waveguide 800. Since the fiber 700 may be disposed normal to the optical waveguiding layer 100 with a high light coupling efficiency, it is possible to reduce the complexity of fabrication and the manufacture cost. For example, there is no need for wafer facet polishing to couple light into the waveguides and the use of grating couplers can allow testing of devices on a wafer before dicing.

In order to design the grating 110 to enhance the coupling efficiency between the fiber 700 and the planar waveguide 800, the width (along the y-axis as shown in FIG. 1a), the etch depth, the number, the period and the duty cycle of the first grating second III may be considered.

For example, the width of the grating III may be designed approximately equal to the mode field diameter (MFD) of the fiber 700, which is used to guide light into/out of the waveguide, so as to obtain a minimum coupling loss.

The etch depth of the grating 111 is relating to the power attenuation coefficient (1/L_{c}) under the grating (or grating characteristic length L_{c}). Larger etch depth would lead to smaller L_{c} or larger power attenuation coefficient 1/L_{c}. In an example, the etch depth of the grating 110 may be designed to satisfy the condition MFD=2.7 L_{c} so as to optimize the out-of-plane coupling.

In yet another implementation, the first grating section 111 is linearly chirped, wherein the grating period satisfies the following formula

Λₚ=Λ₀+(p/n)Δ

Where Λₚ is the period of the p-th grating; Λ₀ is the period of the first grating; Δ is the grating period deviation between the maximum period and the minimum period of the first grating section 111; n is the number of the grating with linearly chirped period; and p is an integer from 0 to n.

As shown in FIG. 1b, the linear chirp is a variation of grating period along the length (along the x-axis as shown in FIG. 1a) of the grating and will reduce the back reflection and enhance the overall coupling efficiency. For vertical out-of-plane coupling, the average period Λ̅=(Λ₀+Λₙ)/2 of the grating 111 is determined by Λ̅=λ/n_{eff-1}, where λ is the center wavelength of the light, n_{eff-1} is the effective refractive index for the light in the first grating region 111, and depends on the material and dimensions of the waveguide and the grating 111. The effective index n_{eff-1} may be calculated by solving Maxwell's equations for certain waveguide dimensions and waveguide materials. The effective refractive index n_{eff-1} may thus vary depending on the etch depth of the grating and the grating duty cycle.

The parameters, including the number n of the chirped periods of the first grating 111 and the grating period deviation Δ of the grating 111, for the chirped section 111 depend on the etch depth, MFD, material refractive indices and waveguide dimensions. For example, the parameters may be determined by numerical simulations with consideration of the etch depth, MFD, material refractive indices and waveguide dimensions thereof.

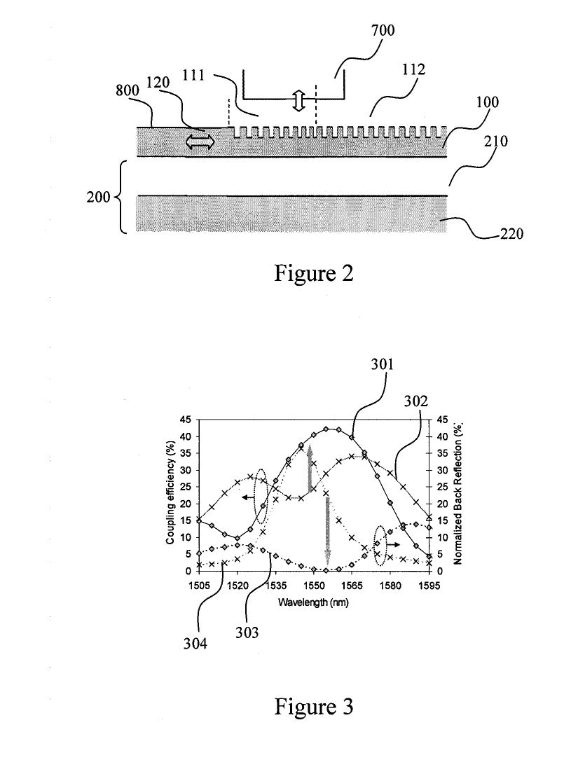

According to still another implementation, the grating section 110 may further comprise a second grating section 112 having uniform periods. As shown in FIG. 2, the linearly chirped grating section 111 is provided in the front end of the grating 110 and the uniform grating section 112 is provided adjacent to the grating section 111.

In the implementation, the width (along the y-axis) and the etch depth of the second grating section 112 may be designed equal to those of the first grating section 111.

The uniform period of the second grating section 112 needed for vertical out-of-plane coupling is Λ=λ/n_{eff-2} where λ is the center wavelength of the light, n_{eff-2} is the effective index for the light in the second grating region 112.

The number of the second grating section 112 is not limited, only if the length of grating 110 (the length of grating 111 plus the length of grating 112) is larger than the mode field diameter of the fiber 700.

Since the effective index n_{eff} is relating to the etch depth of the grating and the grating duty cycle, the period Λ for section 112 may be designed different from the average period Λ̅ of grating section 111 by regulating the duty cycle thereof, so as to optimize the coupling efficiency.

According to a certain implementation, the substrate 200 may include a layer of cladding and a base substrate. The optical waveguiding layer 100 comprises a relatively high index material with respect to the material of the cladding of the substrate 200. The base substrate of the substrate 200 may includes one or more layers. An upper cladding (not shown) may be formed over the optical waveguiding layer 100. For example, the cladding and the upper cladding comprise a relatively low index material than the optical waveguiding layer 100. In an embodiment, the optical waveguiding layer 100, i.e., the grating portion 110 and the tapered guiding portion 120 comprises silicon, for example, crystal silicon. The cladding comprises a layer of silicon dioxide. The base substrate comprises a silicon substrate. Other layers may also be formed on this silicon substrate beneath the optical waveguiding layer 100. The upper cladding comprises for example glass, silicon dioxide, or other material for optically propagating the light between the fiber 700 and the planar waveguide 800. In certain embodiments, the grating portion 110 may comprise doped or undoped polysilicon or single crystal silicon.

According to a second embodiment, the fiber 700 is disposed normal to the waveguide grating 110 of the optical waveguiding layer 100 disposed on the substrate 200. The light is coupled from the planar waveguide 800 to the fiber 700, and the waveguide grating 110 is designed to diffract the light perfectly upwards.

The substrate 200 comprises a layer of silicon substrate 220 and a layer of buried oxide 210 disposed on the silicon substrate 220. The optical waveguiding layer 100 including the grating 110 and the tapered portion 120 is disposed on the buried oxide 210. The optical fiber 700 is a single mode optical fiber. The grating 110 is used for coupling 1550 nm wavelength light from the 220 nm thick silicon waveguide 100 to the single mode optical fiber 700. The refractive index n of the waveguide grating 110, the buried oxide 210, and the silicon substrate 220 is 3.46, 1.46 and 3.46, respectively. The buried oxide layer 210 is of a height about 2 μm. The waveguide grating 110 is fabricated using deep UV lithography on a silicon-on-insulator (SOI) wafer with 220 nm top silicon layer. The fundamental mode of the waveguide may be expanded by the taper portion 120 to a width of 12 μm and coupled out vertically using the etched grating structure. The length of the waveguide grating 110 is about 13 μm. The waveguide grating 110 may comprise 22 periods including 9 non-uniform periods in the first section 111 and 13 uniform periods in the second section 112.

The grating period of the first section 111 satisfies the following formula

Λₚ=Λ₀+(p/8)Δ

Where Λₚ is the period of the p-th grating; p is an integer from 0 to 8; Λ₀=640 nm is the period of the first grating; and Δ=−120 nm is the max grating period deviation. In this way, the average period of the first section 111 is 580 nm with a duty cycle of 53%.

Moreover, in this implementation, the uniform grating period Λ of the second section 112 is designed to be 590 nm with 66% duty cycle. The second section 112 has a larger back reflection to enhance the coupling efficiency.

According to the present implementation, the lateral TE mode profile of the 12 μm-widthed waveguide is well-matched to conventional single mode optical fibers and allows theoretical coupling efficiency as high as 97%.

As stated above, the grating 110 of the second embodiment is employed to efficiently couple the light from the planar waveguide 800 to the optical fiber 700. It is understood, the light from an optical fiber 700 may be efficiently coupled into a planar waveguide device 800 using the grating 110 by passing through the opposite direction as above.

The performance of the grating coupler 110 according to the second embodiment is given below with reference to FIGS. 3-6.

2D FDTD software is used to calculate the performance. A Gaussian waveform with 1/e width of 10.4 μm was employed to represent the fiber mode. Coupling efficiency and the back reflection into the waveguide are shown in FIG. 3. Curves 301 and 303 illustrate a coupling efficiency and a normalized back reflection according to the optical device, respectively. Curves 302 and 304 illustrate a coupling efficiency and a normalized back reflection by employing a uniform grating with a period of 580 nm and a duty cycle of 53%, respectively. As shown in FIG. 2, by employing a section of linearly chirped grating 111, the back reflection from the fiber into the waveguide was dramatically suppressed by the chirped grating and the coupling efficiency is increased to about 42% with a 3 dB bandwidth of 48 nm.

This proposed optical device is a practical and effective device coupling light between waveguides (including silicon and III-V material) and optical fibers. It would be used in the currently available semiconductor devices (lasers, receivers, etc.) as an alternate approach to couple light between them and optical fiber. It would also be a necessary part as the input and output ports for the promising optical integrated circuits.

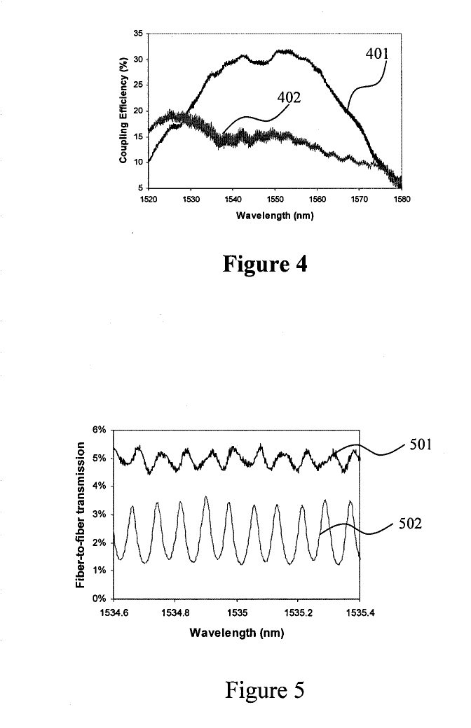

The proposed optical device was fabricated and experimentally characterized. Measurement results of the coupling efficiency between a section of 500 nm-width waveguide with the adiabatic taper and grating couplers are shown in FIG. 4. Curve 402 illustrates a coupling efficiency according to a uniform grating coupler. Curve 401 illustrates a coupling efficiency according to the optical device of an embodiment of the present application, in which the waveguide and taper are lossless and that the input and output grating couplers have the same coupling loss. As shown in FIG. 4, the coupling efficiency of the present optical device is around 32% with a 3 dB bandwidth of 45 nm.

The actual coupling efficiency of the grating is higher if one takes into account the propagation losses of the waveguide and the 4% reflection loss of the fiber facets are included. The back reflection of the grating coupler could also be estimated by the Fabry-Perot interference of the waveguide. The Fabry-Perot interference oscillation of the waveguide with uniform grating couplers as shown in curve 502 was much stronger than the one with chirped grating coupler as shown in curve 501 because of larger reflection in the uniform grating couplers. The contrast of the fringes shown in FIG. 5 indicates that the uniform grating reflectivity was reduced from about 22% to about 4% by the linear chirp in grating period.

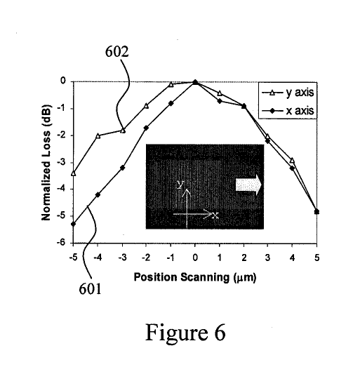

As shown in FIG. 6, curves 601 and 602 show the alignment tolerance to fiber positioning by scanning the fiber position along x and y axis, respectively. The result shown in FIG. 6 indicates good tolerance, with less than 1 dB additional loss from misalignment by 1 μm.

The grating coupler as stated above requires no additional processing, it can reduce back reflections and improve the coupling efficiency compared with a uniform grating, and it can have a relaxed alignment tolerance compared with the adiabatic tapered and polished facets. The proposed coupler with uniform period grating and non-uniform period grating may be fabricated in a single process and provides efficient coupling of light between optical fibers and the waveguides.

According to a third embodiment, an optical system is provided. The optical system comprises an optical fiber; a planar waveguide; and a coupling device for coupling light between the planar waveguide and the optical fiber. The coupling device comprises a planar substrate; and an optical waveguiding layer disposed on the planar substrate. The optical waveguiding layer comprises a grating portion for coupling light between the planar waveguide and the optical fiber; and a tapered guiding portion disposed to convert the mode size between the fiber and the planar waveguide. The grating portion comprises a first grating section having non-uniform periods. The design of the grating portion may be similar to that of the optical device as described above.

While the present application has been illustrated by the above description and embodiments or implementations, it is not intended to restrict or in any way limit the scope of the appended claims thereto.

1. An optical device for coupling light between a planar waveguide and an optical fiber, comprising:
a planar substrate;
an optical waveguiding layer disposed on the planar substrate, the optical waveguiding layer comprising
a grating portion for coupling light between the planar waveguide and the optical fiber; and
a tapered guiding portion disposed to convert the mode size between the fiber and the planar waveguide,
wherein the grating portion comprises a first grating section having non-uniform periods.

2. The optical device of claim 1, wherein the grating portion further comprises a second grating section having uniform periods.

3. The optical device of claim 1, wherein the first grating section has linearly chirped periods.

4. The optical device of claim 3, wherein the optical fiber is positioned normal to a surface of the grating portion.

5. The optical device of claim 4, wherein the average period Λ̅ of the first grating section is determined by Λ̅=λ/n_{eff}, where λ is the center wavelength of the light, n_{eff} is the effective refractive index for the light in the first grating section.

6. The optical device of claim 4, wherein the number of non-uniform periods of the first grating section is designed by numerical simulations with consideration of an etch depth of the first grating section, a mode field diameter of the optical fiber, material refractive indices and waveguide dimensions.

7. The optical device of claim 4, wherein a grating period deviation of the first grating section is designed by numerical simulations with consideration of an etch depth of the first grating section, a mode field diameter of the fiber, material refractive indices and waveguide dimensions.

8. The optical device of claim 1, wherein the tapered guiding portion is an adiabatic taper.

9. An optical system, comprising:
an optical fiber;
a planar waveguide; and
a coupling device for coupling light between the planar waveguide and the optical fiber, the coupling device comprising
a planar substrate;
an optical waveguiding layer disposed on the planar substrate, the optical waveguiding layer comprising
a grating portion for coupling light between the planar waveguide and the optical fiber; and
a tapered guiding portion disposed to convert the mode size between the fiber and the planar waveguide,
wherein the grating portion comprises a first grating section having non-uniform periods.

10. The optical system of claim 9, wherein the grating portion further comprises a second grating section having uniform periods.

11. The optical system of claim 9, wherein the first grating section has linearly chirped periods.

12. The optical system of claim 11, wherein the optical fiber is positioned normal to a surface of the grating portion.

13. The optical system of claim 12, wherein the average period Λ̅ of the first grating section is determined by Λ̅=λ/n_{eff-1}, where λ is the center wavelength of the light, n_{eff-1} is the effective refractive index for the light in the first grating section.

14. The optical system of claim 12 wherein the number of non-uniform periods of the first grating section is designed by numerical simulations with consideration of an etch depth of the first grating section, a mode field diameter of the fiber, material refractive indices and waveguide dimensions.

15. The optical system of claim 12, wherein the grating period deviation of the first grating section is designed by numerical simulations with consideration of an etch depth of the first grating section, a mode field diameter of the fiber, material refractive indices and waveguide dimensions.

16. The optical system of claim 9, wherein the tapered guiding portion is an adiabatic taper.
